(19) United States
(12) Patent Application Publication
(10) Pub. No.: US 2004/0006609 A1
(43) Pub. Date: Jan. 8, 2004

(54) System and method for dynamically extending the capabilities of an application for enhancing a user's web browsing experience

(76) Inventor: Nicholas C. Skrepetos, Eugene, OR (US)

Correspondence Address: MERCHANT & GOULD PC, P.O. BOX 2903, MINNEAPOLIS, MN, 55402-0903, US

(21) Appl. No.: 10/600,951

(22) Filed: Jun. 20, 2003

Related U.S. Application Data
(60) Provisional application No. 60/390,623, filed on Jun. 20, 2002.

(51) Int. Cl. G06F 15/177

(52) U.S. Cl. 709/220

(57) ABSTRACT

A system utilizes an extensible architecture for extending the functionality of an application for enhancing a web browser's experience. The application prevents unwanted advertising and so called “adware” software that launches and/or displays advertising as part of its use on a computing device. As new methods for launching, activating, and running these unwanted advertisements and advertising applications are conceived, the extensible architecture allows the application for preventing these unwanted elements to be dynamically updated to further prevent the new methods.

### RELATED APPLICATIONS

This application claims the benefit of U.S. Provisional Application No. 60/390,623 filed Jun. 20, 2002, which is hereby claimed under 35 U.S.C. §119(e).

### FIELD OF THE INVENTION

The present invention relates to dynamically extending an application's ability to stop, prevent, or alter the display and distribution of unwanted advertising while browsing a computer network.

### BACKGROUND OF THE INVENTION

While browsing a network such as the World Wide Web, or “the web”, users are often presented with unwanted advertising or other information in the form of unwanted advertising or informational windows, banners displayed on the page, advertising that appears over a web page or the like. There are many applications on the market today that are designed to prevent unwanted advertising while browsing a network. As use of these advertising prevention applications becomes more prevalent, advertisers have researched and implemented methods to circumvent these applications.

### SUMMARY OF THE INVENTION

The invention is directed to providing an application that dynamically extends itself to meet the needs of preventing unwanted advertising without the need to re-install the application each time to address new techniques or modify existing techniques.

The present invention allows for preventing unwanted advertisements while avoiding preventing non-advertising material from being displayed. The non-advertising information is maintained to avoid compromising the usefulness of a website. The present invention analyzes the content of a page to determine possible advertising components prior to the display to the user. The update process of the present invention can be automated or activated manually to allow the user full control of the use of system resources. The system also allows the use of a central sever so that rapid deployment of the application updates may be achieved. The present invention facilitates updating and deployment of extensions and enhancements to an application that is designed to prevent or control advertising while browsing a network.

### BRIEF DESCRIPTION OF THE DRAWINGS

FIG. 1 illustrates an exemplary extensible application architecture in accordance with the present invention.

FIG. 2 illustrates an exemplary dynamic extension download process in accordance with the present invention.

FIG. 3 illustrates an exemplary extension update process in accordance with the present invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

The present invention provides an application that dynamically extends itself to meet the needs of preventing unwanted advertising without the need to reinstall the application each time to address new techniques or modify existing techniques.

As application developers stop new types of advertising, the advertisers create new ways of displaying the advertising to circumvent the applications that are designed to stop them. This method requires the end-user of such applications to constantly update their software to keep up with the new advertising as the developers create new ways in which to curtail the new advertising blocking systems. The developers then produce an updated application or version to block the new form of advertising, causing the user to go through the steps of installing, updating, or re-installing the updated applications.

The developers are also required to post new updates to existing software, and deploy the enhancements and updates to the current customer base. With the rate that the new advertising systems are appearing, this may be prohibitive. The updates that are required could be ongoing and occur at a high frequency rate. Users most likely do not desire to download or receive a new update to the advertising stopping program every time a new advertising method is stopped. For example, there could be a new advertising method on a weekly or even daily basis. It is often undesirable for a user to check for program updates and re-install such updates at that frequency, as this consumes unnecessary time and resources. The present invention avoids the requirement of the user implementing the updates to an advertisement blocking application by dynamically updating the application as new methods of presenting advertisements over a network are discovered.

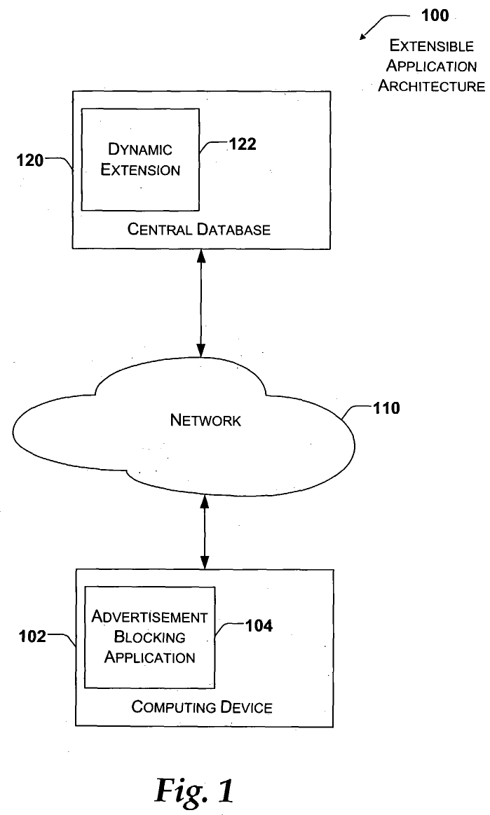

FIG. 1 illustrates an exemplary extensible application architecture (100) in accordance with the present invention. Extensible application architecture 100 includes computing device 102, network 110, and central database 120. Computing device 102 includes an advertising blocking application 104, and network browser application 106 that are both stored in memory on computing device 102. Computing devices are well known in the art and will not be described in detail within this application. Central database 120 includes at least one dynamic extension 122 for download to computing device 102. In further embodiments, central database 120 may include multiple dynamic extensions.

Advertising blocking application 104 operates in combination with network browser application 106 to enhance a user's network browsing experience by preventing unwanted advertisements during a network browsing session. In one embodiment, each dynamic extension downloaded to computing device 102 operates independently of or in combination with the other extensions downloaded to computing device 102.

In one embodiment, dynamic extension 122 is comprised of additional computer code in the form of .DLL, .OCX,. EXE or other executable formatted code, as well as text based instructions on how to interact with a specified advertising method. Dynamic extension 122 also contains domains, script, tags, headings and other descriptive information that specifies detailed information about what websites feature a specific type of advertising and how to optionally remove or prevent such advertising. The updates are stored in central database 120, which, in one embodiment, is comprised of allocated memory on a computing device.

In a further embodiment, dynamic extension 122 further includes descriptive information regarding the extension as well as methods in which to detect and handle the potential advertisement. The descriptive information also contains information regarding specific XML, HTML, DHTML, JavaScript, VBScript, Jscript, or other script or language code to locate and identify an advertisement. The descriptive information also contains specific instructions for the removal of XML, HTML, DHTML, JavaScript, VBScript, Jscript or other script or language code from a web page or application. The removal information may contain, but not be limited to, headings, tags or other identifying marks to describe the detection and subsequent removal or prevention of the advertisement or undesired component.

In yet another embodiment, dynamic extension 122 provides a method to indicate where in the decision-making pipeline or process of advertisement blocking application 104 the operations of dynamic extension 122 should reside. These operations include, but are not limited to, new window creation, start of navigation, end of navigation, completion of document (page) retrieval or loading, or other browser notification event or windows event such as moving, display, or sizing of a window.

In still a further embodiment, each dynamic extension 122 provides a “ranking” or “priority” component to allow the host application to determine the order in which the application extensions and rules are to be processed. The ranking assists in the prevention of accidental misidentification of an advertisement.

In yet another embodiment, dynamic extensions may also be revoked or removed from the extension system. The revocation or removal of extensions may be specified in the central database, such that when the central database is queried for available dynamic extensions, any dynamic extensions requiring revocation may be revoked at that time.

The present invention allows specific code to be downloaded and executed to aid the detection and prevention of unwanted advertising. The specific code may address issues such as new advertising techniques that require the advertising window to be viewed prior to entering a site. The specific code enhancements that the dynamic system provides allow these types of advertising to be confronted with a minimal impact on the end-user. In one example, the specific code may include code for removing advertising designed with the flash system sold under the trademark MACROMEDIA FLASH®. The flash system is used for both advertising and non-advertising content. The present invention distinguishes between advertisements and non-advertisements to provide the user an uninterrupted browsing experience. One method in which flash advertisements are eliminated is by altering the name of the flash advertisement on the page to a name that does not exist on the server. By doing this, the flash system simply ignores the misnamed and non-existent file and the page continues normal processing, but advertisement is not displayed to the user. By allowing specific information describing the targeted advertisement, the display and use of non-advertising material is not affected. The specific names, partial names, domains and other descriptive text are specified in the database so the system can utilize this information to accurately locate the flash file or component within a web page and initiate the removal process. Another method is to simply remove the tag, script, or code from the web page that initiates the use of the specific flash advertisement.

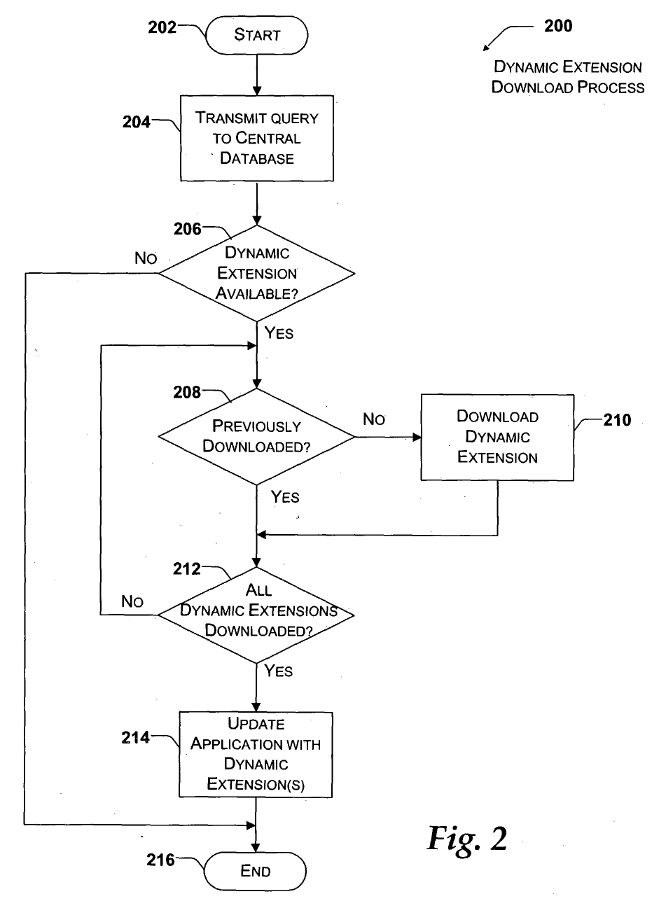

FIG. 2 illustrates an exemplary logic flow diagram for a dynamic extension download process (200) in accordance with the present invention. Process 200 begins at start block 202 where the application for blocking unwanted advertisements is loaded onto a computing device that includes a network browser that is capable of browsing a network such as the web. The process continues at block 204.

At block 204, a query is transmitted by the advertisement blocking application to the central database to determine whether any dynamic extensions are available for download. The query is transmitted via the network connection between the central database and the computing device on which the advertisement blocking application is operating. In one embodiment, the query contains information regarding the state of advertisement blocking application and whether any dynamic extensions have been previously downloaded to this particular computing device. In one embodiment, the query is sent automatically, according to a predetermined schedule, and transparent to the user of the computing device. Once the query is transmitted, processing proceeds to decision block 206.

At decision block 206, a determination is made by the central database upon receipt of the query whether a dynamic extension is available for download. If a dynamic extension is not available for download, processing advances to block 216, where processing ends. However, if a dynamic extension is available for download, processing proceeds to decision block 208.

At decision block 208, a determination is made whether each dynamic extension available for download has been previously downloaded to the computing device that is the source of the query. An identifier included in the query identifies the computing device that is the source of the query. Other information included in the query also lists the dynamic extensions previously downloaded to the particular computing device. The dynamic extension may be categorized by version, date, size, or other indication method that allows the application to realize the availability of the updated information. When each dynamic extension available for download has already been downloaded to the particular computing device that is the source of the query, processing advances to decision block 212. Alternatively, when a dynamic extension available for downloaded has not been downloaded, or requires updating or modification, to the particular computing device that is the source of the query, processing proceeds to block 210.

At block 210, the available dynamic extension determined not to have been previously downloaded, or requires updating or modification, to the particular computing device is then downloaded. The dynamic extension is downloaded via the network from the central database to the particular computing device. In one embodiment, the user is first notified that a download is available before any dynamic extensions are available and allows the user to select whether to proceed with the download. The notification process is an optional process controlled by the user. In a further embodiment, the system provides optional information about each specific extension so that the user is informed of the impact of the extension as well as informed about the advertising method in which it is designed to prevent, allow, or modify. Once the dynamic extension is downloaded, processing proceeds to decision block 212.

At decision block 212, a determination is made whether a dynamic extension is available for download other than the recently downloaded dynamic extension. If another dynamic extension is available for download, the advertisement blocking application may not have been fully updated and processing returns to decision block 208 to determine if this dynamic extension has been previously downloaded to the particular computing device. However, if no further dynamic extensions or modifications to existing dynamic extensions are available for download from the central database, processing proceeds to block 214.

At block 214, the advertisement blocking application is updated with all of the dynamic extensions and modifications to existing extensions received from the central database. Accordingly, the capabilities of the advertisement blocking application is therefore dynamically extended to include the blocking capabilities included in each downloaded dynamic extension. Once the advertisement blocking application is updated, processing advances to block 216, where the process ends.

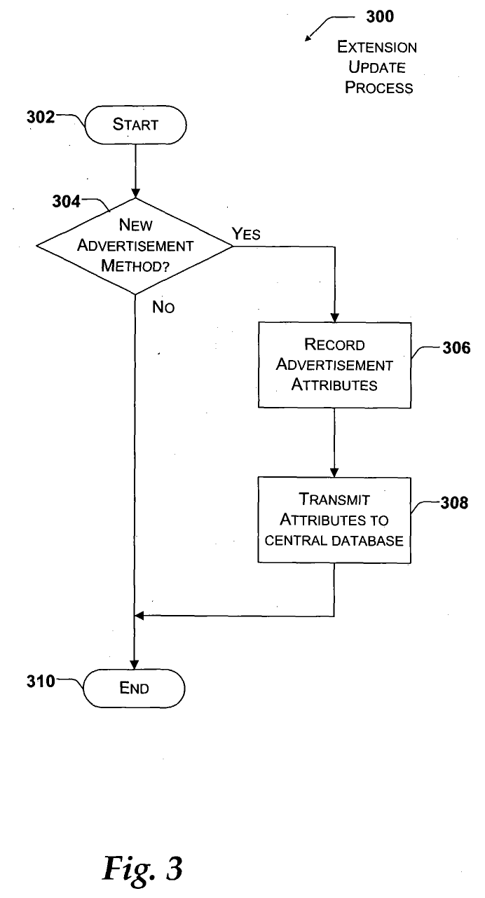

FIG. 3 illustrates an exemplary extension update process (300) in accordance with the present invention. Process 300 begins at start block 302 where the application for blocking unwanted advertisements is activated on a computing device where a user has initiated a network browsing session. The process continues at block 204.

At decision block 304, a determination is made whether a new advertisement method has been encountered during the network browsing session that has not been previously encountered. In one embodiment, this determination is made automatically by a monitoring application associated with the advertisement blocking application. In another embodiment, this determination is made by the user when the user recognizes an unwanted advertisement that was not blocked by the advertisement locking application. If a new advertisement method is not discovered before the end of the browsing session, processing proceeds to block 312 where processing ends. However, if a new method of advertising is discovered during the browsing session, processing proceeds block 306.

At block 306, the attributes of the new advertising method are recorded and stored for transmission to the central database. In one embodiment, the advertisement blocking application automatically recognizes the advertisement as new, and gathers information regarding the advertisement. This information may include the domain of the page on which the advertisement occurred, the method of how the advertisement occurred, and the like. In another embodiment, the user is allowed to enter the specific information regarding a domain or advertising method. The specific information comports with a rules system where the user can describe the advertisement or domain that served or displayed the advertisement and instruct the system to prevent, allow or otherwise modify the actions of the advertising. Once this information is recorded for the new advertising method, processing proceeds to block 308.

At block 308, the information gathered regarding the new advertising method is transmitted via the network from the computing device to the central database. At the central database, this information may be used by developers to generate new dynamic extensions to prevent these unwanted advertisements in the future. Once the gathered attributes have been transmitted to the central database, processing proceeds to block 310, where the process ends.

The above specification, examples and data provide a complete description of the manufacture, use, and composition of the invention. Since many embodiments of the invention can be made without departing from the spirit and scope of the invention, the invention resides in the claims hereinafter appended.

I claim:

1. A computer-implemented method for dynamically extending an application stored on a computing device for blocking unwanted advertisements, comprising:
querying a central database to identify any available dynamic extensions for the application;
downloading any dynamic extensions to the computing device that have not been previously downloaded; and
updating the application to include further advertisement blocking functionality provided by any downloaded dynamic extensions.

2. The computer-implemented method of claim 1, wherein the dynamic extension results from an extension update process, comprising:
monitoring a network browsing session for any newly discovered methods of advertising;
recording attributes of a newly discovered method for advertising when the newly discovered method for advertising is encountered; and
transmitting the attributes to the central database such that the dynamic extension is generated in response to the attributes of the newly discovered method for advertising.

3. The computer-implemented method of claim 2, wherein the attributes comprise at least one of a domain of the page on which the advertisement occurred and the method of how the advertisement occurred.

4. The computer-implemented method of claim 1, wherein the dynamic extension comprises additional computer code in the form of a group comprising .DLL, .OCX, and .EXE.

5. The computer-implemented method of claim 1, wherein the dynamic extension comprises text based instructions on how to interact with a specified advertising method.

6. The computer-implemented method of claim 1, wherein the dynamic extension comprises information regarding at least one of XML, HTML, DHTML, JavaScript, VBScript, and Jscript used to locate and identify an advertisement.

7. The computer-implemented method of claim 1, wherein the dynamic extension comprises information for removing at least one of XML, HTML, DHTML, JavaScript, VBScript, and Jscript from a web page.

8. The computer-implemented method of claim 1, further comprising notifying a user prior to downloading any dynamic extensions to the computing device.

9. The computer-implemented method of claim 8, further comprising providing the user with a selection of whether to continue with downloading any dynamic extensions to the computing device.

10. The computer-implemented method of claim 8, further comprising providing optional information about each specific extension such that the user is informed of the impact of the dynamic extension and the advertising method to which the dynamic extension applies.

11. A computer-readable medium encoded with computer-executable instructions for performing a method comprising:
querying a central database to identify any available dynamic extensions for an advertisement blocking application stored on a computing device;
determining whether any available dynamic extensions have been previously downloaded to the computing device;
downloading any dynamic extensions to the computing device that have not been previously downloaded; and
updating the advertisement blocking application to reflect further advertisement blocking functionality provided by any downloaded dynamic extensions.

12. The computer-readable medium of claim 11, wherein the dynamic extension is generated from an extension update process, comprising:
monitoring a network browsing session for any newly discovered methods of advertising;
recording attributes of a newly discovered method for advertising when the newly discovered method for advertising is encountered; and
transmitting the attributes to the central database such that the dynamic extension is generated in response to the attributes of the newly discovered method for advertising.

13. The computer-readable medium of claim 11, further comprising notifying a user prior to downloading any dynamic extensions to the computing device.

14. The computer-readable medium of claim 13, further comprising providing the user with a selection of whether to continue with downloading any dynamic extensions to the computing device.

15. The computer-readable medium of claim 13, further comprising providing optional information about each specific extension such that the user is informed of the impact of the dynamic extension and the advertising method to which the dynamic extension applies.

16. A system for dynamically extending an advertisement blocking application that is stored on a computing device, comprising:
a dynamic extension that is downloadable to the computing device via a network, wherein the dynamic extension comprises information for extending the functionality of the advertisement blocking application; and
a central database that is configured to store the dynamic extension when generated, wherein the dynamic extension is generated according to an extension update process comprising:
monitoring a network browsing session for any newly discovered methods of advertising;
recording attributes of a newly discovered method for advertising when the newly discovered method for advertising is encountered; and
transmitting the attributes to the central database such that the dynamic extension is generated in response to the attributes of the newly discovered method for advertising.

17. The system of claim 16, wherein the dynamic extension is downloaded to the computing device in response to a query from the computing device.

18. The system of claim 16, wherein the central database determines whether a particular dynamic extension has previously been downloaded to the computing device prior to downloading the particular dynamic extension.

19. The system of claim 16, wherein information for extending the functionality of the advertisement blocking application includes at least one of information regarding where in the decision-making pipeline of the advertisement blocking application operations of the dynamic extension reside, and a ranking component that allows the advertisement blocking application to determine the order in which the application extensions and rules are processed.

20. The system of claim 16, wherein the user is optionally notified prior to downloading any dynamic extensions to the computing device and the user is at least one of provided with a selection of whether to continue with downloading any dynamic extensions to the computing device, and provided optional information about each specific extension such that the user is informed of the impact of the dynamic extension and the advertising method to which the dynamic extension applies.
